(19) United States
(12) Patent Application Publication
(10) Pub. No.: US 2009/0190735 A1
(43) Pub. Date: Jul. 30, 2009

(54) METHOD AND SYSTEM FOR ENHANCING TELEMATICS SERVICES

(75) Inventors: David P. Gilmartin, Rochester Hills, MI (US); Edward P. Chrumka, Grosse Pointe Park, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, Detroit, MI (US)

(21) Appl. No.: 12/019,617

(22) Filed: Jan. 24, 2008

(51) Int. Cl. H04M 3/42

(52) U.S. Cl. 379/201.12

(57) ABSTRACT

A method for enhancing telematics services is disclosed. The method includes capturing a voice print of a user and receiving a verbal request for a telematics service. A voice associated with the verbal request is compared with the captured voice print, and if the voice associated with the verbal request matches the captured voice print, a telematics unit associated with the user is instructed to activate a service that fulfills the verbal request.

### TECHNICAL FIELD

The present disclosure relates generally to methods and systems for enhancing telematics services.

### BACKGROUND

Remote access to various vehicle components and/or systems, such as, e.g., door locks, engine start, adjustment to climate control, and/or the like, is currently available for many vehicle users. In some instances, the user may be verified or otherwise authenticated before he/she is able to access, either internally or remotely, a vehicle component and/or system. Authentication may be accomplished, for example, via a personal identification code or an account number accompanied with a password. If the user recites the appropriate personal identification code, account number, and/or password, the user is authenticated and may then be allowed to access the desired vehicle component and/or system.

### SUMMARY

A method for enhancing telematics services is disclosed. The method includes capturing a voice print of a user and receiving a verbal request for a telematics service. A voice associated with the verbal request is compared with the captured voice print, and if the voice associated with the verbal request matches the captured voice print, a telematics unit associated with the user is instructed to activate a service that fulfills the verbal request.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting a system for enhancing telematics services;

FIG. 2 is a flow diagram depicting a method for enhancing telematics services; and

FIG. 3 is a schematic flow diagram depicting another method for enhancing telematics services.

### DETAILED DESCRIPTION

Examples of the method and system, as disclosed herein, advantageously enable a user to access (locally or remotely) various vehicle components and/or systems without having to provide a personal identification number, account number and/or a password. This is accomplished by capturing a voice print of the user associated with the vehicle, and comparing the voice of a verbal request for services with the captured voice print to authenticate the user associated with the verbal request. If the user is authenticated (i.e., a match exists between the voice associated with the verbal request and the captured voice print), the service request is fulfilled.

The method and system disclosed herein also advantageously enhance the handling of calls received by a call center. A user's call may be directed to an appropriate department (e.g., a live advisor or a security module) based on the nature of the call. This is accomplished by determining what the call pertains to prior to transferring the call. It is believed that such screening will reduce the number of calls that are 1) transmitted to a live advisor or 2) exposed to security provisions when such a connection is not necessary to achieve the user's request.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. As such, indirect communication may include communication between two components with additional component(s) located therebetween.

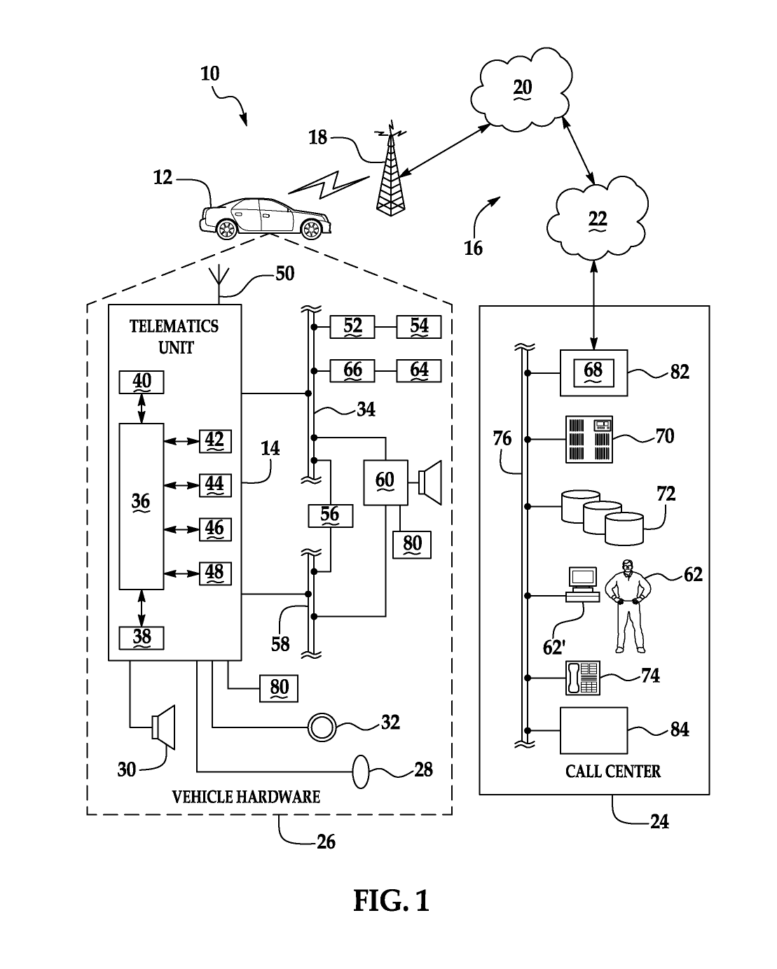

Referring now to FIG. 1, the system 10 includes a vehicle 12, a telematics unit 14, a wireless carrier/communication system 16 (including, but not limited to, one or more cell towers 18, one or more base stations and/or mobile switching centers (MSCs) 20, one or more land networks 22, one or more service providers (not shown)), and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software (e.g., computer readable code) that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 80, which may be operatively connected to the telematics unit 14 directly, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes a telephony system 82 with one or more switches 68; servers 70; databases 72; live and/or automated advisors 62; 62′; security module(s) 84; as well as a variety of other telecommunication and computer equipment 74 that is known to those skilled in the art. These various call center components are coupled to one another via a network connection or bus 76, such as the one (vehicle bus 34) previously described in connection with the vehicle hardware 26. The live advisor 62 may be physically present at the call center 24 or may be located remote from the call center 24 while communicating therethrough. It is to be understood that the security module(s) 84 may be physically present at the call center 24 or may be located remote from the call center 24. In one example, the security module(s) 84 may be hosted on a remote server (not shown).

Switch 68, which may be a private branch exchange (PBX) switch, routes incoming signals so that voice transmissions are usually sent to the security module 84, the live advisor 62 or an automated response system 62′, and data transmissions are passed on to a modem or other piece of equipment (not shown) for demodulation and further signal processing. The telephony system 82 and switch 68, in conjunction with the network connection or bus 76, act as a means (e.g., a communication system) for transmitting voice or data transmissions from call center 24 to the vehicle 12.

The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

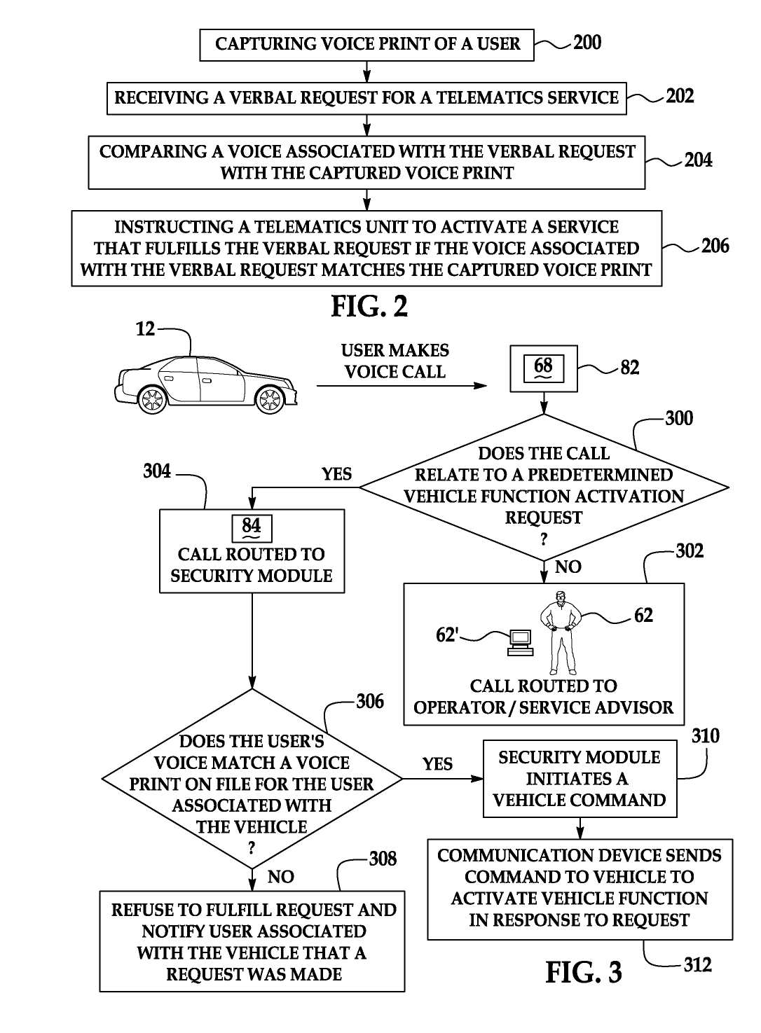

The security module 84 generally has at least two modes, a voice print capture mode and a vehicle command mode. The module 84 also includes suitable hardware and/or software for receiving verbal communications from the user and for recording such verbal communications. During voice print capture mode, the security module 84 captures (receives and records) a user's voice print, and transmits the voice print to be stored in the user's profile record. In a non-limiting example, the verbal communications may be received over the land network 22 and processed by the security module 84. The verbal communications may then be stored in the user's profile record or account in one of the databases 72. In some instances, voice print capture mode is activated during the initial configuration or provisioning of the telematics unit 14 (e.g., when the user first initiates telematics unit service). During vehicle command mode, the security module 84 initiates a vehicle command instructing the communication device (e.g., telephony system 82 and switch 68) to send a command to the vehicle 12 to activate a vehicle function that is responsive to a user's request. Generally, the security module 84 enters vehicle command mode after determining that a caller's voice (i.e., the voice then currently making the request) matches the on-file voice print for a user associated with the vehicle 12. It is to be understood that both voice print mode and vehicle command mode will be described further hereinbelow in reference to FIGS. 2 and 3.

In some instances, in addition to the voice print match, the caller may further be authenticated by providing accurate personal data associated with one or more prescribed challenges. Such additional authentication is also discussed further hereinbelow.

It is to be understood that, although a service provider (not shown) may be located at the call center 24, the call center 24 is a separate and distinct entity from the service provider. In an example, the service provider is located remote from the call center 24. A service provider provides the user with telephone and/or Internet services. The service provider is generally a wireless carrier (such as, for example, Verizon Wireless®, AT&T®, Sprint®, etc.). It is to be understood that the service provider may interact with the call center 24 to provide service(s) to the user.

An example of a method for enhancing telematics services is depicted in FIG. 2. The method generally includes capturing a voice print of a user, as shown at reference numeral 200; receiving a verbal request for a telematics service, as shown at reference numeral 202; comparing a voice associated with the verbal request with the captured voice print, as shown at reference numeral 204; and instructing a telematics unit 14 to activate a service that fulfills the verbal request if the voice associated with the verbal request matches the captured voice print, as shown at reference numeral 206.

The voice print of a user is generally captured by the security module 84 during the voice print capture mode, as provided above. This is accomplished by receiving a verbal communication from the user and recording the received communication to form a voice print. Non-limiting examples of suitable verbal communications include names, passwords, or the like. While the user's voice print is often captured during telematics unit 14 provisioning, it is to be understood that the user's voice print may be captured at any desirable time. For example, the voice print may be captured when the user renews his/her telematics unit 14 service contract (e.g., if the voice print was not captured during provisioning).

Either the user or the call center 24 initiates the voice call with the other party. Generally, the call is associated with telematics unit 14 provisioning or service renewal, and as such, the switch 68 of the call center 24 directs the user to the security module 84 for voice capture.

Receiving the voice communication by the security module 84 is accomplished by the user inputting the verbal communication into a communications device, and a communication system (e.g., wireless carrier/communication system 16) transmitting the verbal communication to the security module 84. In some instances, inputting may be accomplished using a communications device associated with the telematics unit 14 located inside the vehicle 12. In other instances, inputting may be accomplished using a communications device located outside of the vehicle 12.

In an example, the verbal communication is received by the telematics unit 14 via the in-vehicle microphone 28, an in-vehicle telephone (not shown in FIG. 1), or some other available in-vehicle communications device. If, for example, the user's voice communication is input using the microphone 28, the microphone 28 may be activated by, e.g., pressing a button that is operatively connected to the microphone 28 and to the telematics unit 14. The user may then proceed to input his/her voice communication into the activated microphone 28. The voice communication is received by the telematics unit 14, which in turn transmits the inputted verbal communication to the security module 84, where the verbal communication is recorded (e.g., digitally).

In another example, the verbal communication is received by the telematics unit 14 via a remote device such as, e.g., a personal computer. The user's voice is transmitted through the wireless carrier/communication system 16 to the telematics unit 14 using voice-over internet protocol (VoIP).

In still another example, the verbal communication is input from a communications device located outside of the vehicle 12. Non-limiting examples of suitable communication devices that may be used outside of the vehicle 12 include cellular phones, landline phones, or the like. After the user inputs the verbal communication into the communications device located outside of the vehicle 12, the inputted verbal communication is then transmitted from the communications device to the security module 84. As previously described, when this particular voice call is established, the call center 24 directs the user to the security module 84 for capturing the user voice print. It is to be understood that, in this example, the telematics unit 14 is not configured during the voice print capture mode since the telematics unit 14 is not in communication with the call center 24.

The security module 84 transmits the recorded voice print to a profile record associated with the user. The captured voice print stored in the record may then be used to authenticate the user when a verbal request for a particular telematics service is made.

In an example, a user makes a verbal request for a telematics service by initiating a voice call using, e.g., the user's cellular phone, a landline phone, a communications device operatively connected to the telematics unit 14, or another similar communications device. The voice call may be made by the user when the user is located inside the vehicle 12 or when the user is located outside of the vehicle 12. Non-limiting examples of verbal requests include a request for navigation instructions or turn-by-turn routing assistance, a request for addition of phone units to a user's account, a request for remote door unlock, a request for remote engine start, a request for adjustment of climate control settings, a request for radio station presets, a request for accident assistance, a request for authenticating the vehicle as an in-fleet or rental vehicle, a request for emergency services, a request for good Samaritan and/or Amber alerts, a request for hands-free voice-activated phone services, a request for remotely activating a horn and/or lights, a request for riding assistance, a request for roadside assistance, an automatic notification of airbag deployment, a request for crisis assistance, a request for a demonstration of telematics services, a request for diagnostics of the vehicle, a request for stolen vehicle location assistance, a request for stolen vehicle slowdown, a request for vehicle information, maintenance, and/or warranty information, a request for virtual advisors and/or other connected domains, and/or the like, and/or combinations thereof. It is to be understood that the previously listed requests are non-limiting, and that many of the requests (for example, requests for: navigation instructions, addition of phone units, adjustment of climate control and/or radio station presets) may be made remote from the vehicle 12 or from within the vehicle 12.

The voice call is received by an interactive voice response system associated with the call center 24. In a non-limiting example, the interactive voice responsive system is a communications system, such as the telephony system 82 (as shown in FIG. 1).

In the example shown in FIG. 2, after receiving the verbal request for a telematics service from the user, the voice associated with the verbal request is compared, via the security module 84, with the captured voice print to determine if a match exists. In some instances, the voice print with which the requesting voice is compared with one on file for the user associated with the telematics unit 14 or vehicle 12 from which the request is received. In other instances, when the verbal request is made from outside the vehicle 12, the call center 24 may determine which user profile to access (to retrieve the stored voice print) by recognizing that the number from which the request is received is associated with a particular user (e.g., a user's cell phone number is stored in his/her profile), by requesting the caller's name, identification number and/or password, and/or by some other suitable means for initially identifying (not necessarily authenticating) the caller.

Once the security module 84 retrieves the stored voice print, it compares the print with the caller's voice. If the security module 84 determines that the voices match, the caller has been authenticated and the telematics unit 14 is commanded or otherwise instructed to activate a service that fulfills the verbal request.

In addition to determining if the requesting voice matches the voice print, the caller may, in some instances, further be authenticated by answering one or more prescribed challenges. The prescribed challenge(s) may include a question or request for information relating to personal information of the user, such as, e.g., “What is your mother's maiden name?”, “What was the name of your first pet?”, “Describe the color of your first car,” and/or the like. The answers to these questions or requests (i.e., the personal data) are originally answered by the user and are stored in the user's profile record. When the caller requests a service, the caller will be presented with one or more of the prescribed challenges, which he/she must answer correctly, in addition to the voice match, to be authenticated.

Once the caller has been authenticated, the security module 84 generally initiates a vehicle command. This vehicle command generally informs the telephony system 82 that the requester/caller has been authenticated, and that such command (or another, perhaps more detailed, command) may be sent to the telematics unit 14 associated with the authenticated user instructing it to perform some function that will satisfy the request. The command is transmitted to the telematics unit 14 from the call center 24 via the wireless carrier/communication system 16.

In response to receiving such a command, the telematics unit 14 performs the function, and the request is fulfilled. It is to be understood that if the telematics unit 14 is in “sleep” mode when the call center 24 attempts to send the command, the call center 24 may awaken the telematics unit 14 so that the function (e.g., remote door unlock, remote engine start) may be performed. In other instances when the telematics unit 14 is in “sleep” mode, the call center 24 may store the command in a temporary cache, and transmit it if the telematics unit 14 enters “awake” mode within the time frame that the command is stored. Otherwise, the call center 24 may delete the command when the telematics unit 14 is in “sleep” mode, and inform the requester that the telematics unit 14 needs to be activated to fulfill the request.

In a non-limiting example, a caller requests remote vehicle 12 door unlock. He/she would make such a verbal request via an out-of vehicle communications device (e.g., a cellular phone) since he/she is not able to unlock the vehicle 12. The request is received by a communications device (e.g., telephony system 82) of the call center 24. The call center telephony system 82 recognizes that the request requires user authentication prior to being fulfilled, and transmits the call (e.g., via bus 76) to the security module 84. Since the user is calling from an out-of-vehicle communications device, the security module 84 identifies the caller (e.g., by asking his/her name) and retrieves a voice print from a profile associated with, for example, that particular name.

The security module 84 compares the voice associated with the verbal request with the retrieved captured voice print. If the security module 84 determines that a match exists between the voice and the captured voice print, the security module 84 will send a command, via the telephony system 82 and the wireless communication system 16, to the telematics unit 14 to fulfill the request. The command is understood by the telematics unit 14, which performs a function to unlock the doors of the vehicle 12.

In the event that the voice associated with the verbal request does not match the retrieved captured voice print, the security module 84 notifies the caller that he/she has not been recognized as the authorized user, and that the requested service will not be provided. Using the foregoing example, if the security module 84 determines that a match does not exist between the voice associated with the verbal request and the retrieved captured voice print, the security module 84 may inform a call center advisor 62, 62′ to notify an authorized user that an unauthorized attempt to obtain telematics services has been performed and refused.

In the method and system 10 disclosed herein, it is to be understood that an authorized user may consent to adding additional voice prints to his/her profile. As such, one or more other users may be added to the user's record and authorized to receive telematics services via the original user's account. For example, a vehicle owner may add his/her spouse and/or child(ren) as authorized user(s). This may be accomplished by the requesting, via the user associated with the particular profile, that the other user(s) be added to the user's profile. A voice print for each of the other user(s) is captured and stored in the original user's record. In this instance, a voice call including a verbal request for telematics services is compared to any of the captured voice prints stored in the user's profile. If the security module 84 determines that a comparison between the then-current caller/requester's voice and any of the captured voice prints results in a match, the security module 84 will command the telematics unit 14 to fulfill the request. If, however, a comparison between the caller's voice and any of the captured voice prints does not result in a match, then the requested service is refused.

Without being bound by any theory, it is believed that the method and system 10 disclosed herein also enhance routing of calls (and in particular service requests) through the call center 24. This may be accomplished by initially determining a particular category for the call and/or the service request. After determining the nature of the call/request, the switch 68 of the call center 24 directs the user's call to an appropriate department/entity. In some instances, the switch 68 determines whether the call relates to a predetermined vehicle function activation. The activation of some vehicle functions may require user authentication. In such instances, it may not be desirable to direct the call to an advisor 62, 62′, but rather to the security module 84. It is to be understood that the predetermined vehicle function activation requests (e.g., services requiring user authentication) may be set by the call center 24, the user, the company offering the services, and/or combinations thereof.

As an example, if the call is related to a service request for a predetermined vehicle function activation that requires user authentication (e.g., remote door unlock, remote engine start, setting/changing radio presets, addition of phone units to an account, etc.), the call will be directed to the security module 84 (as opposed to a live advisor 62) for user verification/authentication. As another example, if the call is related to a service request that does not require user authentication (e.g., navigation instructions, climate control settings, etc.), the call may be directed to the live advisor 62 or the automated advisor 62′, who will in turn deal with the request.

Another example of the method used by the system 10 for enhancing telematics services is depicted in FIG. 3. In this particular example, a user, from inside the vehicle 12, makes a voice call and establishes a connection with the telephony system 82 of the call center 24 using the in-vehicle telematics unit 14 or some other communications device. The user verbally requests one or more telematics services. The telephony system 82 determines whether the voice call relates to a predetermined vehicle function activation request, as shown at reference numeral 300.

If the telephony system 82 determines that the service request does not relate to a predetermined vehicle function activation, the telephony system 82 routes the voice call to one of several operators or service advisors 62, 62′ located at the call center 24, as shown at reference numeral 302. As previously described, such requests generally do not require user authentication, and as such, an advisor 62, 62′ may assist the user once the call is transferred.

If, however, the telephony system 82 determines that the service request is related to a predetermined vehicle function activation (generally requiring user authentication prior to fulfilling such a request), the telephony system 82 routes the voice call to the security module 84, as shown at reference numeral 304.

The security module 84 then compares the voice associated with the verbal request (i.e., the caller's voice) with a captured voice print to determine if there is a match, as shown at reference numeral 306. As previously mentioned, if the call is made from the in-vehicle telematics unit 14, the security module 84 can retrieve the profile associated with that telematics unit 14. If the call is made from a non-in-vehicle communications device, the security module 84 can retrieve the profile based on information provided by the caller (e.g., a name) and/or by recognizing that the non-in-vehicle communications device is associated with a particular user profile.

If the security module 84 determines that there is a match, the security module 84 initiates a vehicle command, as shown at reference numeral 310. This command may be directed to the telephony device 82 requesting that the device 82 transmit a particular activation function command to the telematics unit 14. Alternatively, this command may include a particular activation function command that is sent to the vehicle 12 via the call center 24 communications device (such as the telephony device 82). The command instructs the telematics unit 14 to activate a vehicle function that fulfills the user's request, as shown at reference numeral 312.

However, if the security module 84 determines that the voice associated with the verbal request and the retrieved captured voice print do not match, the security module 84 will refuse to fulfill the request, and will notify the caller to that effect.

While several examples have been described in detail, it will be apparent to those skilled in the art that the disclosed embodiments may be modified. Therefore, the foregoing description is to be considered exemplary rather than limiting.

1. A method for enhancing telematics services, the method comprising:
capturing a voice print of a user;
receiving a verbal request for a telematics service;
comparing a voice associated with the verbal request with the captured voice print; and
instructing a telematics unit associated with the user to activate a service that fulfills the verbal request if the voice associated with the verbal request matches the captured voice print.

2. The method as defined in claim 1 wherein an interactive voice response system is configured to receive the verbal request and a security module is configured to compare the voice associated with the verbal request with the captured voice print.

3. The method as defined in claim 1, wherein the voice associated with the verbal request is associated with a caller, and wherein the method further comprises:
requesting personal data from the caller in response to one or more prescribed challenges; and
instructing the telematics unit to activate the service that fulfills the verbal request if a response to the personal data request correctly answers the one or more prescribed challenges.

4. The method as defined in claim 1 wherein capturing the voice print of the user is accomplished during provisioning of the telematics unit.

5. The method as defined in claim 1 wherein capturing the voice print of the user is accomplished by:
receiving a verbal communication from the user; and
recording the user's verbal communication.

6. The method as defined in claim 5 wherein receiving the verbal communication is accomplished by:
inputting the verbal communication via an in-vehicle microphone, an in-vehicle telephone, a cellular phone, or a landline telephone; and
transmitting the verbal communication to a security module at a call center via a communication system.

7. The method as defined in claim 5 wherein the verbal communication is selected from a name or a password.

8. The method as defined in claim 1 wherein the voice associated with the verbal request does not match the captured voice print, and wherein the method further comprises refusing to provide a service that fulfills the verbal request.

9. The method as defined in claim 1, further comprising storing the voice print in a record associated with the user.

10. The method as defined in claim 9, further comprising:
receiving a request from a user to add an other user to the user's record;
capturing a voice print of the other user; and
storing the voice print of the other in the user's record.

11. The method as defined in claim 1 wherein the verbal request is received via a voice call, and wherein prior to comparing the voice associated with the verbal request with the captured voice print, the method further comprises:
determining whether the verbal request relates to a predetermined vehicle function activation request;
routing the voice call to a security module if the verbal request relates to the predetermined vehicle function activation request; and
routing the voice call to an operator if the verbal request does not relate to the predetermined vehicle function activation request;
wherein the security module compares the voice associated with the verbal request with the captured voice print and provides the service if the voice associated with the verbal request matches the captured voice print.

12. The method as defined in claim 11 wherein the voice call is received from a user located outside a vehicle associated with the user.

13. A system for enhancing telematics services, the system comprising:
a telephony system for receiving a verbal request from a user for a telematics service;
a security module configured to capture a voice print of a user, compare a voice associated with the verbal request with the captured voice print, and initiate a command responsive to the verbal request if the voice matches the captured voice print; and
a communication system for sending a command to a vehicle to fulfill the verbal request if the voice request matches the captured voice print.

14. The system as defined in claim 13, further comprising a telematics unit associated with the user, wherein the security module is configured to capture the user's voice print during provisioning of the telematics unit.

15. The system as defined in claim 13 wherein the security module includes:
means for receiving a verbal communication from the user; and
means for recording the user's verbal communication.

16. The system as defined in claim 15, further comprising:
a communication device for inputting the verbal communication, wherein the communication device is selected from an in-vehicle microphone, an in-vehicle telephone, a cellular phone, or a landline telephone; and
a communication system for transmitting the verbal communication from the communication device to the means for receiving.

17. The system as defined in claim 13 wherein the telephony system and the security module are located at a call center.

18. The system as defined in claim 17, further comprising a record, associated with the user and maintained at the call center, for storing the voice print.

19. A system for enhancing telematics services, comprising:
a call center;
a vehicle;
a telematics unit in the vehicle for communicating with the call center and for receiving vehicle function activation commands from the call center;
a plurality of operator stations at the call center;
a telephony system at the call center for:
receiving a call from a user of the vehicle placed from a device outside of the vehicle;
determining whether the call relates to a predetermined vehicle function activation request;
routing the call to a security module within the call center if the call relates to the predetermined vehicle function activation request; and
routing the call to an operator if the call does not relate to the predetermined vehicle function activation request;
wherein the security module includes a voice print capture mode and a vehicle command mode, wherein the security module initiates a vehicle command in response to the predetermined vehicle function activation request if a voice of the user matches a voice print captured by the security module during the voice print capture mode; and
a communication device for sending a command, in response to the initiated vehicle command from the security module, to the vehicle to activate a vehicle function in response to the vehicle function activation request.
